(19) United States
(12) Patent Application Publication
(10) Pub. No.: US 2010/0148413 A1
(43) Pub. Date: Jun. 17, 2010

(54) THREE-STATE SWITCHABLE HYDRAULIC MOUNT

(75) Inventor: Ping Lee, Kitchener (CA)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/333,583

(22) Filed: Dec. 12, 2008

(51) Int. Cl. F16F 5/00

(52) U.S. Cl. 267/140.11

(57) ABSTRACT

An inertia track assembly for coupling first and second fluid chambers includes first and second tracks in fluid communication with the first and second chambers, the second having a decoupler disposed therein. A shaft is movably disposed to intersect the first and second tracks, and configured to selectively move between at least two positions. A first position allows fluid communication between the first and second chambers through the first track, but blocks fluid communication between the second track and one of the chambers. A second position allows fluid communication between the second track and the chambers, but blocks fluid communication through the first track. The shaft may have a third position, which blocks fluid communication through both the first and second tracks. First and second passages may be disposed in the shaft to selectively allow fluid communication between the first and second tracks, respectively.

### TECHNICAL FIELD

This disclosure relates generally to mount assemblies for vibration damping and control, and, more particularly, to hydraulic mount assemblies.

### BACKGROUND OF THE INVENTION

Engines, powertrain components, and other heavy components in industrial applications that generate vibrations when operating may be suspended on resilient mounts that isolate and damp the vibration from reaching the passenger compartment of the vehicle. Hydraulic mount assemblies may be used in automotive and industrial applications to damp such vibrations. Vibrations and excitations occur at variable frequencies and amplitudes, and, as such, a variable response may be utilized to isolate or damp vibrations coming from a source such as an engine or powertrain component.

### SUMMARY

An inertia track assembly for coupling first and second fluid chambers is provided. The inertia track assembly includes a first track in fluid communication with the first and second chambers, and a second track in fluid communication with the first and second chambers and having a decoupler element disposed therein. A shaft is movably disposed to intersect the first track and the second track along an axis, and is configured to selectively move between at least two positions.

The first position allows fluid communication through the first track between the first and second chambers, but blocks fluid communication between the second track and one of the first and second chambers. The second position allows fluid communication between the second track and the first and second chambers, but blocks fluid communication between the first track and either the first or second chamber.

The shaft may be further configured to selectively move to a third position, which blocks fluid communication between the first and second chambers through both of the first and second tracks. The inertia track assembly may include a first passage disposed in the shaft and configured to selectively allow fluid communication between the first track and the first and second chambers, and a second passage disposed in the shaft and configured to selectively allow fluid communication between the second track and the first and second chambers.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic, cross-sectional view of a hydraulic mount having an inertia track assembly, showing the inertia track assembly set to a first state;

FIG. 2 is a schematic, plan view of the inertia track assembly shown in FIG. 1, showing the inertia track assembly set to a second state (which is also shown in FIG. 3);

FIG. 3 is a schematic, cross-sectional view of the inertia track assembly shown in FIG. 1, showing the inertia track assembly again set to the second state; and

FIG. 4 is a schematic, cross-sectional view of the inertia track assembly shown in FIG. 1, showing the inertia track assembly set to a third state.

### DESCRIPTION OF PREFERRED EMBODIMENTS

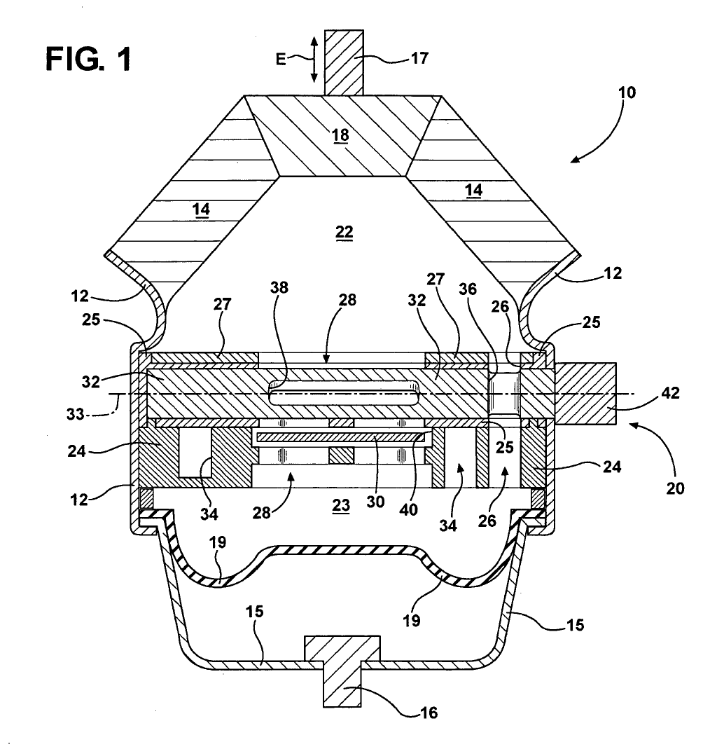

Referring to the drawings, wherein like reference numbers correspond to like or similar components throughout the several figures, there is shown in FIG. 1 an embodiment of a hydraulic mount 10, which may be an engine mount or a mount supporting other structure. While the present invention is described in detail with respect to automotive applications, those skilled in the art will recognize the broader applicability of the invention. Those having ordinary skill in the art will further recognize that terms such as “above,” “below,” “upward,” “downward,” et cetera, are used descriptively of the figures, and do not represent limitations on the scope of the invention, as defined by the appended claims.

Hydraulic mount 10 includes an outer member 12, which interfaces with a main rubber element 14 (the upper end, as shown in FIG. 1) and a bottom housing 15 (the lower end, as shown in FIG. 1). Outer member 12 is fixedly coupled to a lower stud 16 of a vehicle. The main rubber element 14 is attached to an inner member 18, which is attached, such as by an upper stud 17, to the engine or some other oscillating object. Relative motion between the lower stud 16 and the upper stud 17 is indicated by arrow E.

The upper and lower portions of the hydraulic mount 10 are generally separated by an inertia track assembly 20. Hydraulic mount 10 is filled with a fluid such as liquid glycol. Main rubber element 14, inner member 18, and the inertia track assembly 20 form a first fluid chamber 22 (the upper fluid chamber, as viewed in FIG. 1). Inertia track assembly 20 and a bellows 19 form a second fluid chamber 23 (the lower fluid chamber). First and second fluid chambers 22 and 23 are in variable fluid communication through the inertia track assembly 20.

Inertia track assembly 20 includes a bottom plate 24 and a main body 25 having various cavities and passageways (discussed in more detail herein) formed or machined therein. A cover plate 27 is placed on one end—in FIG. 1, toward the main rubber element 14 of the hydraulic mount 10—of the main body 25. Other embodiments of the inertia track assembly 20 may be formed from fewer elements, such as forming all necessary cavities and passageways in the bottom plate 24 or main body 25, only.

As vibrations, excitations, or other irregular displacements (shown as arrow E) are introduced from the engine into the upper stud 17, the hydraulic mount 10 dampens or isolates the vibrations to limit the amount of force transferred to the lower stud 16. The degree of dynamic stiffness and damping of hydraulic mount 10 depends, in part, on the ease with which the fluid flows between the first and second fluid chambers 22 and 23.

Passages or tracks are formed through the bottom plate 24, main body 25, and cover plate 27 between the first and second fluid chambers 22 and 23. A first track 26 is in fluid communication with the first fluid chamber 22 and the second fluid chamber 23. A second track 28 is in fluid communication with the first fluid chamber 22 and the second fluid chamber 23. A decoupler 30 is disposed within the second track 28, such that fluid cannot easily and continuously flow between the first and second fluid chambers 22 and 23 through the second track 28. Fluid must flow around the edges of the decoupler 30 in order to flow through the second track 28.

A shaft 32 is movably disposed within the main body 25 to intersect the first track 26 and the second track 28 along an axis 33 running lengthwise through the shaft 32. Therefore, depending upon the position of the shaft 32, fluid flow to the first and second tracks 22 and 23 may be obstructed, blocked completely, or able to flow substantially freely.

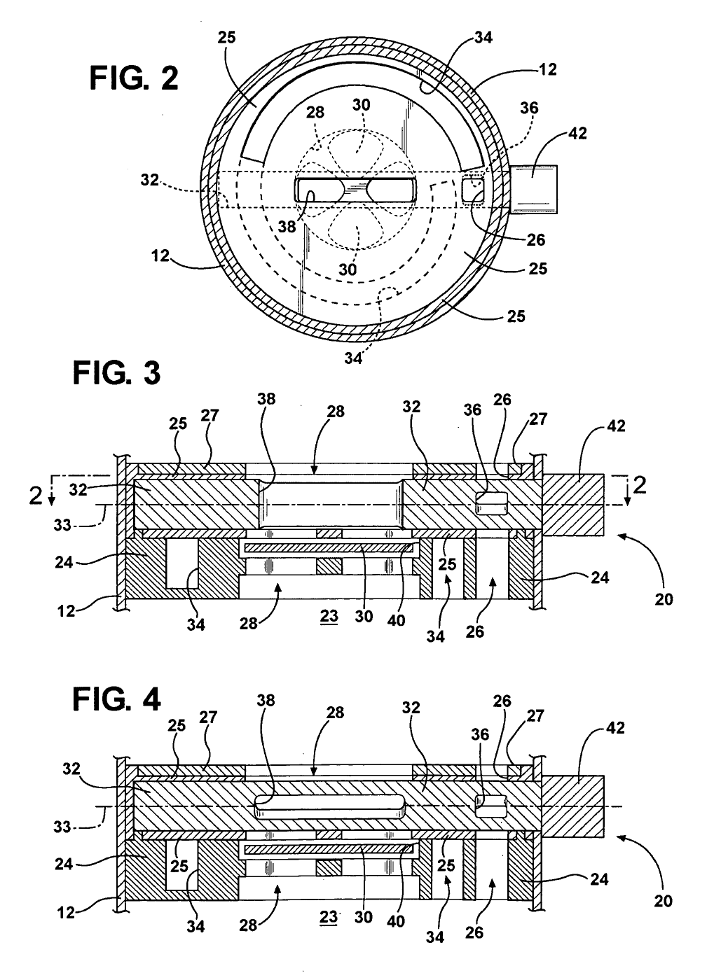

With continued reference to FIG. 1, there is shown in FIG. 2 a plan view of the inertia track assembly 20 shown in FIG. 1, viewed from above (as if looking down from the main rubber element 14,) showing the main body 25 and also the shaft 32 and bottom plate 24 in phantom. Inertia track assembly 20 alters the dynamic stiffness by varying the ability of fluid to displace between the first and second fluid chambers 22 and 23.

A third track 34 is also in fluid communication with the first fluid chamber 22 and the second fluid chamber 23. The shape and path of the third track 34 is defined by the bottom plate 24, main body 25, and cover plate 27.

First track 26 is configured to have a greater resistance to flow than second track 28 and the decoupler 30. The difference in flow resistance may be achieved either by making second track 28 shorter or having a greater cross-section. In the embodiment shown in FIG. 1, second track 28 is substantially wider than first track 26.

Decoupler 30 is positioned in the second track 28 and configured to reciprocate or oscillate in response to vibrations so as to produce small volume changes between the first and second fluid chambers 22 and 23. When the decoupler 30 is moved toward the second fluid chamber 23, it compensates for the volume lost due to the compression of the first fluid chamber 22, and does so with very low dynamic resistance. The decoupler 30 does not allow fluid to flow through the second track 28 between the first and second fluid chambers 22 and 23.

The compensated volume is transferred to the second fluid chamber 23 by the displacement of the decoupler 30 and then may be accommodated by expansion of the bellows 19, internal losses, and/or other damping elements. When the inertia track assembly 20 is oriented such that the decoupler 30 is unconstrained, the hydraulic mount 10 exhibits low dynamic rigidity to isolate vibrations and little hydraulic damping is provided by the inertia track assembly 20. However, this effect lasts only through the compensating range of the decoupler 30, which is limited.

The third track 34 has substantially greater flow resistance than first track 26 and also higher fluid inertia than first track 26, and therefore provides greater dynamic stiffness and damping than the first track 26 and the second track 28. Third track 34 is not intersected by the shaft 32, and therefore, in this embodiment, is always open to the first and second fluid chambers 22 and 23.

The hydraulic mount 10 generally has two functions: to provide engine isolation and also to control engine motion. However, increasing levels of isolation or control may result in a decrease in the other. Generally, control may be achieved with increased damping, which reduces the vibration of the engine. Isolation may be achieved by low dynamic stiffness, to isolate the vibrations; however, increased damping would cause increased vibrations. As dynamic stiffness and damping increase, the ability to isolate vibration decreases.

Therefore, the hydraulic mount 10 and inertia track assembly 20 are configured to change states. Depending upon the operating conditions of the vehicle, the inertia track assembly 20 provides little or no damping to create a soft response and isolate vibrations. In other operating conditions, the inertia track assembly 20 provides higher damping to control vibrations.

The shaft 32 is configured to selectively open or block the first track 26 and the second track 28, thereby selectively enabling or disabling the respective damping responses of first and second tracks 26 and 28. Shaft 32 selectively allows fluid communication into, or through, the first and second tracks 26 and 28 by selectively positioning passages or courses, each of which links a respective one of the first and second tracks 26 and 28 with either or both of the first and second fluid chambers 22 and 23.

A first passage 36 is disposed in the shaft 32 and configured to selectively allow fluid communication between the first track 26 and the first and second fluid chambers 22 and 23. In the embodiment shown in FIGS. 1 and 2, the first passage 36 is substantially perpendicular to the axis 33 of shaft 32 and its center generally intersects the axis 33. However, in alternative embodiments (not shown), the passages need not be perpendicular to the axis 33 and may be configured with cavities offset from the axis 33 such that fluid flows around the axis 33 and between the shaft 32 and the bottom plate 24.

A second passage 38 disposed in the shaft 32 and configured to selectively allow fluid communication between the second track 28 and both of the first and second fluid chambers 22 and 23. Opening the second track 28 allows fluid flow from the first fluid chamber 22 to the decoupler 30 and from the second fluid chamber 23 to the decoupler 30, such that the decoupler 30 is free to oscillate within the second track 28.

The operation of hydraulic mount 10 and inertia track assembly 20 may be described as follows. In response to engine or road excitation (shown as arrow E), fluid is displaced by the main rubber element 14 from first fluid chamber 22 toward second fluid chamber 24. The degree of dynamic stiffness and damping of hydraulic mount 10 depends, in part, on the ease with which the fluid flows through the inertia track assembly 20 and the masses of fluid in the first fluid track 26 and third fluid track 34.

The fluid in the first fluid track 26 and third fluid track 34 participates in a resonant system whose frequency is based on such properties as the mass of fluid in the track, elasticity of the main rubber member 14 and bellows 19, the volumetric dilation of the first and second fluid chambers 22 and 23, and fluid volumetric displacements. Since ease of flow through first fluid track 26 and third fluid track 34 depends on track length, cross-section, surface friction, and fluid entry and exit area constrictions and refractions, the tracks can also be tuned to provide a differential resistance to flow.

The shaft 32 is configured to move to one of at least three positions, corresponding to three selectable damping/isolation states for the hydraulic mount 10. In the embodiment shown in the figures, movement of shaft 32 occurs by rotating the shaft 32 about the axis 33. However, in other embodiments, the shaft 32 could be moved linearly along the axis 33; or, alternatively, the shaft 32 could be flattened and moved perpendicularly to the axis (up and down, as viewed in FIG. 2).

FIG. 1 shows the inertia track assembly 20 in a first position. The shaft 32 moves (rotates) to align the first passage 36 with the first track 26 to allow fluid to flow through the first track 26 between the first and second fluid chambers 22 and 23.

In the first position, the shaft 32 also blocks fluid flow between the second track 28 and one of the first and second fluid chambers 22 and 23. While the second track 28 is blocked, decoupler 30 is constrained such that it cannot move or oscillate in response to displacement of fluid in either the first or second fluid chambers 22 and 23. The third track 34 remains open to both the first and second fluid chambers 22 and 23.

The first position may be used for vehicle speeds less than or equal to a predetermined speed, for example five miles-per-hour (mph). This may be referred to as the idle state or idle-in-drive state, in which the engine speed is at or near idle speed and minimal road excitation is expected. First track 26 may be referred to as the idle track.

Fluid from first fluid chamber 22 flows through the first track 26 rather than through the third track 34 because the dynamic resistance of the fluid column in the third track 34 is designed to be greater than that of the fluid column in the first track 26. The ratio of the cross-sectional area to the length of the first track 26 may be significantly greater than that of the third track 34.

Accordingly, the resonant frequency is higher with flow through the first track 26 than with flow through the third track 34. This may lead to a favorable reduction in the dynamic stiffness at a targeted range of frequencies that correspond to large periodic engine excitations typically encountered during idle operation.

If unusually large amplitude excitations occur while the inertia track assembly 20 is in the first position (idle state)—such as those occurring where the vehicle hits a large bump while driving at low speeds—the increase in pressure may overcome the inertia of the fluid in the third track 34 and cause fluid to also flow through the third track 34. The third track 34 may be referred to as the bounce track or bounce inertia track, as the increase inertia of the fluid in the third track 34 works to damp large amplitude vibrations.

FIGS. 2 and 3 show the inertia track assembly 20 in a second position, the driveaway state. FIG. 2 is a top view taken along the section line 2-2 shown in FIG. 3. In the second positions, shaft 32 moves (rotates) to align the second passage 38 with the second track 28 to allow fluid to flow into, and out of, the second track 26 from the first and second fluid chambers 22 and 23. In the second position, the shaft 32 also blocks fluid flow between the first track 26 and one of the first and second fluid chambers 22 and 23. The third track 34 remains open to both the first and second fluid chambers 22 and 23.

While the second track 28 is open, decoupler 30 is not constrained and may move or oscillate in response to displacement of fluid in either the first or second fluid chambers 22 and 23. The second position, or driveaway state, may correspond to speeds between about 5 mph and 50 mph. The decoupler 30 is permitted to articulate in response to volumetric displacement of the first fluid chamber 22, and no fluid flows through the first track 26. In the driveaway state (position 2), the hydraulic mount 10 exhibits a low dynamic stiffness to provide maximum isolation over the frequency range encountered in the vehicle speed range, which is approximately 5-50 mph in this embodiment.

Where the volume displaced due to the compression of the first fluid chamber 22 exceeds or overcomes the capacity of the decoupler—during, for example, large amplitude, low frequency, road excitations—fluid will flow through the third track 34 (the bounce inertia track). Therefore, during the driveaway state, the second position allows the inertia track assembly 20 to provide two different dynamic stiffness rates: first, a relatively low level of damping and stiffness to isolate low amplitude inputs, and then a high level of damping to absorb and control high amplitude inputs. This transition occurs as the excitations transition from low to high amplitudes, respectively.

Decoupler 30 may be a fixed decoupler element having an elastomeric diaphragm, or a floating decoupler element. A fixed decoupler element expands to transfer volumetric displacement between the first and second fluid chambers 22 and 23, compensating for small amplitude volume displacements, and thereby preventing fluid motion in the third track 34. The range of compensation for a fixed decoupler element is determined, at least in part, by the size and elasticity of the elastomeric diaphragm, and generally increases as the fixed decoupler element compensates for more volume displacement.

The decoupler 30 shown in the figures is a floating decoupler element, which compensates by floating or sliding within a decoupler pocket 40. As decoupler 30 moves through the decoupler pocket 40, it compensates nearly exactly for the volume of fluid displaced by the relative motion between the upper stud 17 and lower stud 16. In one embodiment, the floating decoupler 30 is a disc-shaped rubber member. Those having ordinary skill in the art will recognize further designs for the floating decoupler 30, based upon the specific application for the hydraulic mount 1O.

When decoupler 30 reaches the end of the decoupler pocket 40, it stops and no longer compensates for any further volume displacement. Once the floating decoupler 30 reaches the end of the decoupler pocket 40, substantially all additional displacement between first and second fluid chambers 22 and 23 must be accommodated by fluid flow through an open track. However, there may be some fluid flow or leakage around the edges of the floating decoupler 30.

In one embodiment of the inertia track assembly 20, the decoupler pocket 40 has approximately one millimeter of total travel or gap, which is the peak-to-peak range of the decoupler 30. Therefore, the decoupler 30 reciprocates with displacement in either direction of up to approximately 0.5 millimeters. Those having ordinary skill in the art will recognize that the gap distance may be greater or lesser for specific applications.

FIG. 4 shows the inertia track assembly 20 in a third position, the highway cruising state. The shaft 32 moves (rotates) to block fluid flow to both the first track 26 and the second track 28, such that the decoupler 30 is constrained and fluid cannot pass between the first and second fluid chambers 22 and 23 via the first track 26. In the third position, only the third track 34 remains open to transfer volumetric displacement between the first and second fluid chambers 22 and 23.

The third position may be utilized at speeds greater than approximately 50 mph (such as highway cruising). Any displaced fluid is forced to flow through the third track 34. Thus, the mount provides very high dynamic stiffness, which may attenuate smooth road shake on the vehicle floor and at the steering wheel.

Those having ordinary skill in the art will recognize that the assignment of the three positions to specific driving states (idle, driveaway, and highway cruising) are only exemplary. Furthermore the definitions and ranges of the driving states are exemplary only, and other driving conditions may be factored into the determination of which damping characteristics best suit which driving states. Additionally, the inertia track assembly 20 may be tuned to alter the damping response of the hydraulic mount 10 to differing vehicle and engine conditions.

In the embodiment shown in FIGS. 1-4, movement of the shaft 32 between the first, second, and third positions is accomplished with a motor 42. The motor 42 may be a step motor configured to selectively rotate the shaft 32 between each of the three positions. A controller or processor (not shown) may be used to determine the desired position of the shaft 32 and to operate the motor 42.

Note that because there are three positions, when transitioning between positions, the shaft 32 never has to move through one position to get to another. For example, the inertia track assembly 20 may move from the first position (idle state) directly to the third position (highway cruising state) without first entering (or crossing) the second position (driveaway state). In the embodiment of the shaft 32 shown in FIGS. 1-4, the first passage 36 is offset from the second passage 38 by approximately sixty degrees.

Multiple hydraulic mounts 10 may be used on a vehicle or piece of industrial equipment to damp or isolate the powertrain. These mounts may all be identical or similar, or may incorporate differing rates of damping versus isolation in each of the three states of operation.

While the best modes and other embodiments for carrying out the claimed invention have been described in detail, those familiar with the art to which this invention relates will recognize various alternative designs and embodiments for practicing the invention within the scope of the appended claims.

1. An inertia track assembly for coupling a first fluid chamber with a second fluid chamber, comprising:
a first track in fluid communication with the first chamber and the second chamber;
a second track in fluid communication with the first chamber and the second chamber, having a decoupler element disposed therein; and
a shaft movably disposed to intersect said first track and said second track along an axis, wherein said shaft is configured to selectively move to a first position to allow fluid communication through said first track between the first and second chambers and to block fluid communication between said second track and one of the first and second chambers, and said shaft is configured to selectively move to a second position to allow fluid communication between said second track and the first and second chambers and to block fluid communication between said first track and one of the first and second chambers.

2. The assembly of claim 1, wherein said shaft is configured to selectively move to a third position to block fluid communication between said first track and one of the first and second chambers, and to block fluid communication between said second track and one of the first and second chambers.

3. The assembly of claim 2, further comprising:
a first passage disposed in said shaft and configured to selectively allow fluid communication between said first track and the first and second chambers; and
a second passage disposed in said shaft and configured to selectively allow fluid communication between said second track and the first and second chambers.

4. The assembly of claim 3, further comprising a motor operatively connected to said shaft, wherein said motor is configured to selectively move said shaft to one of said first, second, and third positions.

5. The assembly of claim 4, wherein said motor is configured to rotate said shaft about said axis to select one of said first, second, and third positions.

6. The assembly of claim 5, wherein said motor is a step motor.

7. The assembly of claim 6, wherein said decoupler element is a floating decoupler.

8. The assembly of claim 7, wherein said first and second passages are offset by approximately sixty degrees of rotation about said axis.

9. The assembly of claim 8, further comprising a third track in fluid communication with the first chamber and the second chamber, and having substantially greater volume than the volume of said first track.

10. An inertia track assembly for coupling a first fluid chamber with a second fluid chamber, comprising:
a first track in fluid communication with the first chamber and the second chamber;
a second track in fluid communication with the first chamber and the second chamber;
a decoupler element disposed within said second track;
a third track in fluid communication with the first chamber and the second chamber, and having substantially greater volume than the volume of said first track; and
a shaft movably disposed to intersect said first track and said second track along an axis, wherein said shaft is configured to selectively move between:
a first position configured to allow fluid communication through said first track between the first and second chambers and to block fluid communication between said second track and one of the first and second chambers, and
a second position configured to allow fluid communication between said second track and the first and second chambers and to block fluid communication between said first track and one of the first and second chambers.

11. The assembly of claim 10, wherein said shaft is further configured to selectively move to a third position configured to block fluid communication between said first track and one of the first and second chambers, and to block fluid communication between said second track and one of the first and second chambers.

12. The assembly of claim 11, wherein said decoupler element is a floating decoupler.

13. The assembly of claim 12, further comprising a step motor operatively connected to said shaft, wherein said motor is configured to selectively rotate said shaft about said axis to select one of said first, second, and third positions.

14. The assembly of claim 13, further comprising:
a first passage disposed in said shaft and configured to selectively allow fluid communication between said first track and the first and second chambers; and
a second passage disposed in said shaft and configured to selectively allow fluid communication between said second track and the first and second chambers.

15. The assembly of claim 14, wherein said first and second passages are offset by approximately sixty degrees of rotation about said axis.
